(19) United States
(12) Patent Application Publication
(10) Pub. No.: US 2026/0023785 A1
(43) Pub. Date: Jan. 22, 2026

(54) PROPERTY INDEX CREATION METHOD AND APPARATUS FOR GRAPH DATABASE, DEVICE, AND STORAGE MEDIUM

(71) Applicant: Alipay (Hangzhou) Information Technology Co., Ltd., Hangzhou (CN)

(72) Inventor: Wuke ZHANG, Hangzhou (CN)

(21) Appl. No.: 19/275,922

(22) Filed: Jul. 21, 2025

(30) Foreign Application Priority Data
Jul. 22, 2024 (CN) 202410985088.0

(51) Int. Cl. G06F 16/901; G06F 16/22

(52) U.S. Cl. CPC G06F 16/9024; G06F 16/2228

(57) ABSTRACT

One or more embodiments of this application provide a property index creation method and apparatus for a graph database, a device, and a storage medium. The method includes: in response to a data import operation for the graph database, importing to-be-stored data specified by the data import operation into the graph database for storage, and determining whether inventory data is stored in the graph database, where the inventory data is data for which a property index corresponding to a property index definition is not created; determining the inventory data and the to-be-stored data as target data if the inventory data is stored in the graph database, or determining the to-be-stored data as the target data if the inventory data is not stored in the graph database; and creating the property index corresponding to the property index definition for the target data based on the property index definition.

### TECHNICAL FIELD

One or more embodiments of this application relate to the field of artificial intelligence technologies, and in particular, to a property index creation method and apparatus for a graph database, a device, and a storage medium.

### BACKGROUND

A graph database stores and manages data in a graph structure. A node, an edge, and a property are used to represent and store the data. Such a storage manner is very suitable for expressing a complex relationship between entities. In the graph database, the node represents an entity, for example, a person, a location, or an event; and each node can have a plurality of properties to describe specific information of an entity. The edge is used to represent a relationship between nodes, for example, “knowing”, “belonging”, and “located”. The edge can also include a property to describe a characteristic of the relationship, for example, strength of the relationship or a creation time. The property is a data field that is attached to the node or the edge and that is used to store the specific information, for example, a name, an age of a person, or a start date of a relationship.

When storing the data, the graph database can follow storage policies such as native graph storage, columnar storage, distributed storage, and index. The native graph storage is that the graph database directly stores the data in a native graph structure. To be specific, a layout is performed based on a logical relationship between a node, an edge, and a property on a disk, thereby optimizing graph traversal and query performance. To accelerate a query, the graph database can further create an index for an ID, a label, and a property of the node and the edge. This is similar to an index mechanism in a relational database, which helps quickly locate a specific data item. In actual applications, how to create a highly available index for data stored in the graph database has become a problem of great concern.

### SUMMARY

Technical solutions provided in one or more embodiments of this application are as follows:

This application provides a property index creation method for a graph database. The method includes:
in response to a data import operation for the graph database, importing to-be-stored data specified by the data import operation into the graph database for storage, and determining whether inventory data is stored in the graph database, where the inventory data is data for which a property index corresponding to a property index definition is not created;
determining the inventory data and the to-be-stored data as the target data if the inventory data is stored in the graph database, or determining the to-be-stored data as the target data if the inventory data is not stored in the graph database; and
creating the property index corresponding to the property index definition for the target data based on the property index definition.

This application further provides a property index creation apparatus for a graph database. The apparatus includes:
a check module, configured to: in response to a data import operation for the graph database, import to-be-stored data specified by the data import operation into the graph database for storage, and determine whether inventory data is stored in the graph database, where the inventory data is data for which a property index corresponding to a property index definition is not created;
a determining module, configured to: determine the inventory data and the to-be-stored data as the target data if the inventory data is stored in the graph database, or determine the to-be-stored data as the target data if the inventory data is not stored in the graph database; and
a creation module, configured to: create the property index corresponding to the property index definition for the target data based on the property index definition.

This application further provides an electronic device, including:
a processor; and
a memory, configured to store processor-executable instructions, where
the processor runs the executable instructions to implement any one of the steps of the method.

This application further provides a computer-readable storage medium. The computer-readable storage medium stores computer instructions, and when the instructions are executed by a processor, any one of the steps of the method is implemented.

In the above-mentioned technical solutions, when the to-be-stored data specified by the data import operation for the graph database is imported into the graph database for storage, whether inventory data for which a property index corresponding to a property index definition is not created is stored in the graph database can be determined. If yes, the inventory data and the to-be-stored data can be jointly determined as target data; otherwise, the to-be-stored data can be directly determined as target data. Subsequently, the property index corresponding to the property index definition can be created for the determined target data based on the property index definition.

In the above-mentioned manner, for the inventory data that is stored in the graph database and for which the property index corresponding to the property index definition is not created, creating the property index corresponding to the property index definition for the inventory data may not be manually triggered by a user, but the property index corresponding to the property index definition is automatically created for the inventory data, thereby ensuring timeliness and reliability of creating the property index, so that when stored data with a specific property is queried in the graph database, an accurate query result can be obtained based on the property index.

### BRIEF DESCRIPTION OF DRAWINGS

The following describes the accompanying drawings required for describing example embodiments.

FIG. 1 is a schematic diagram of a graph database system according to an example embodiment of this application;

FIG. 2 is a flowchart of a property index creation method for a graph database according to an example embodiment of this application;

FIG. 3 is a flowchart of another property index creation method for a graph database according to an example embodiment of this application;

FIG. 4 is a schematic structural diagram of a device according to an example embodiment of this application; and

FIG. 5 is a block diagram of a property index creation apparatus for a graph database according to an example embodiment of this application.

### DESCRIPTION OF EMBODIMENTS

Example embodiments are described in detail herein, and examples of the example embodiments are presented in the accompanying drawings. When the following description relates to the accompanying drawings, unless specified otherwise, same numbers in different accompanying drawings represent same or similar elements. Implementations described in the following example embodiments do not represent all implementations consistent with one or more embodiments of this application. On the contrary, the embodiments are merely examples consistent with some aspects of one or more embodiments of this application.

It should be noted that, in some other embodiments, the steps of the corresponding method are not necessarily performed in the order shown and described in this application. In some other embodiments, the method can include more or fewer steps than that described in this application. In addition, a single step described in this application may be split into a plurality of steps in other embodiments for description; and a plurality of steps described in this application may be combined into a single step in other embodiments for description.

When storing data, a graph database can follow storage policies such as native graph storage, columnar storage, distributed storage, and index. The native graph storage is that the graph database directly stores the data in a native graph structure. To be specific, a layout is performed based on a logical relationship between a node, an edge, and a property on a disk, thereby optimizing graph traversal and query performance. To accelerate a query, the graph database can create an index for an ID, a label, and a property of the node and the edge. This is similar to an index mechanism in a relational database, which helps quickly locate a specific data item.

When using the graph database, a user needs to query, based on a specified property, the data stored in the graph database. Therefore, a property index needs to be created for the data stored in the graph database, so that stored data with the specified property can be queried efficiently in the graph database based on the property index.

Usually, in the graph database, the user can import data into the graph database for storage by using a data import operation. For example, many graph databases support importing data by using a CSV file. Therefore, the user can first prepare the CSV file for each of a node and an edge in the graph database. Each CSV file includes a corresponding ID, label, property, etc. Then, data of two types, namely, the node and the edge into which the ID, the label, the property, etc. included in the CSV file is organized is imported into the graph database for storage by using a data import tool (for example, a graphical user interface (GUI), a command line tool, or an API interface) corresponding to the graph database.

When the data is imported into the graph database for storage, the property index can be created for a property of currently imported data based on the property index definition. The property index definition is a manner and rule of creating and configuring an index for a property of a node or edge in the graph database. To be specific, a specific property index can be created for a specific property of the data stored in the graph database based on the property index definition.

However, for data that is stored in the graph database and for which the property index corresponding to the property index definition is not created, the property index is not created for a property of the data based on the property index definition during data importing, but the user needs to manually trigger index recreation, to create a specific property index for the specific property of the data based on the property index definition.

In addition, full data and a property index of the full data are usually stored in the graph database without supporting expiry-based eviction. For a computing analysis scenario that relies on only recent data (for example, data in one recent month), expired historical data affects computing and analysis efficiency to some extent.

In addition, the property index in the graph database is usually backed up in a manual full backup manner. However, when a backup time interval is large, a large quantity of property indexes may be lacked or missing, which is not conducive to disaster recovery of the property index.

This application provides a technical solution of property index creation for a graph database. In this technical solution, when to-be-stored data specified by a data import operation for the graph database is imported into the graph database for storage, whether inventory data for which a property index corresponding to a property index definition is not created is stored in the graph database can be determined. If yes, the inventory data and the to-be-stored data can be jointly determined as target data; otherwise, the to-be-stored data can be directly determined as target data. Subsequently, the property index corresponding to the property index definition can be created for the determined target data based on the property index definition.

In the above-mentioned manner, for the inventory data that is stored in the graph database and for which the property index corresponding to the property index definition is not created, creating the property index corresponding to the property index definition for the inventory data may not be manually triggered by a user, but the property index corresponding to the property index definition is automatically created for the inventory data, thereby ensuring timeliness and reliability of creating the property index, so that when stored data with a specific property is queried in the graph database, an accurate query result can be obtained based on the property index.

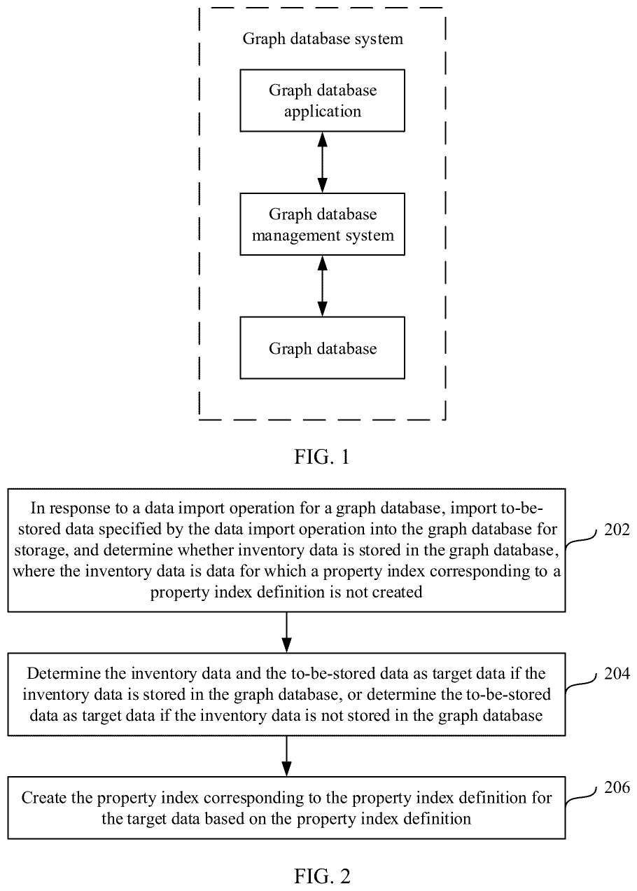

FIG. 1 is a schematic diagram of a graph database system according to an example embodiment of this application.

As shown in FIG. 1, the graph database system can include at least a graph database, a graph database management system (GDBMS), and a graph database application.

The graph database is a place at which data is actually stored. The stored data is organized into a node and an edge. Each node and each edge can have a respective property. In the graph database, the node represents an entity, for example, a person, a location, or an event; and each node can have a plurality of properties to describe specific information of an entity. The edge is used to represent a relationship between nodes, for example, “knowing”, “belonging”, and “located”. The edge can also include a property to describe a characteristic of the relationship, for example, strength of the relationship or a creation time. The property is a data field that is attached to the node or the edge and that is used to store the specific information, for example, a name, an age of a person, or a start date of a relationship.

The graph database management system is a core component for controlling and managing the graph database, and can be used to define, create, maintain, and operate the graph database. The graph database management system provides an interface for a creation operation, a read operation, an update operation, and a delete operation, and is also responsible for consistency, security, and backup recovery of data.

The graph database application is a front-end application that interacts with the graph database, and is configured to implement specific service logic and functions. The graph database application can provide a user-oriented interface, and can be specifically a graphical user interface, a command line, or another form of interface.

The graph database and the graph database management system can be deployed on a server. The server can be a server that includes one independent physical host, or can be a server cluster that includes a plurality of mutually independent physical hosts. Alternatively, the server can be a virtual server, a cloud server, etc. carried by a host cluster. The graph database application can be deployed on a terminal device for which a network (including a plurality of types of wired networks or wireless networks) connection to the server is established. The terminal device can be a personal computer (PC), a desktop computer, a notebook computer, a tablet computer, a smartphone, a personal digital assistant (PDA), etc.

In actual applications, a user can initiate a specific operation (for example, a data import operation or an index recreation operation) for the graph database by using the graph database application, and the graph database management system can perform these operations for the graph database.

FIG. 2 is a flowchart of a property index creation method for a graph database according to an example embodiment of this application.

As shown in FIG. 2, the property index creation method for a graph database can include the following steps.

Step 202: In response to a data import operation for the graph database, import to-be-stored data specified by the data import operation into the graph database for storage, and determine whether inventory data is stored in the graph database, where the inventory data is data for which a property index corresponding to a property index definition is not created.

In this embodiment, the to-be-stored data specified by the data import operation can be imported into the graph database for storage in response to the data import operation for the graph database. In this case, the property index corresponding to the property index definition may not be created for the to-be-stored data (namely, currently imported data) temporarily based on the property index definition. Instead, whether the inventory data is stored in the graph database is first determined. The inventory data is data that is stored in the graph database and for which the property index corresponding to the property index definition is not created.

In actual applications, the property index can be predefined in the graph database, or the property index definition can be specified by the data import operation. This is not specifically limited in this application.

Step 204: Determine the inventory data and the to-be-stored data as the target data if the inventory data is stored in the graph database, or determine the to-be-stored data as the target data if the inventory data is not stored in the graph database.

In this embodiment, if it is determined that the inventory data is stored in the graph database, the inventory data and the to-be-stored data can be jointly determined as target data used to create the property index, to jointly create the property index for the inventory data and the to-be-stored data.

If the inventory data is not stored in the graph database, the to-be-stored data can be directly determined as target data used to create the property index, to directly create the property index for the to-be-stored data.

Step 206: Create the property index corresponding to the property index definition for the target data based on the property index definition.

In this embodiment, when the target data is determined, the property index corresponding to the property index definition can be created for the target data based on the property index definition.

Specifically, if the target data includes the inventory data and the to-be-stored data, the property index corresponding to the property index definition can be jointly created for the inventory data and the to-be-stored data when the to-be-stored data is imported into the graph database for storage.

If the target data includes only the to-be-stored data, the property index corresponding to the property index definition can be created for the to-be-stored data when the to-be-stored data is imported into the graph database for storage.

In actual applications, the created property index can be a property index in a graph database implemented based on Lucene.

In the above-mentioned embodiment, when the to-be-stored data specified by the data import operation for the graph database is imported into the graph database for storage, whether the inventory data for which the property index corresponding to the property index definition is not created is stored in the graph database can be determined. If yes, the inventory data and the to-be-stored data can be jointly determined as target data; otherwise, the to-be-stored data can be directly determined as target data. Subsequently, the property index corresponding to the property index definition can be created for the determined target data based on the property index definition.

In the above-mentioned manner, for the inventory data that is stored in the graph database and for which the property index corresponding to the property index definition is not created, creating the property index corresponding to the property index definition for the inventory data may not be manually triggered by a user, but the property index corresponding to the property index definition is automatically created for the inventory data, thereby ensuring timeliness and reliability of creating the property index, so that when stored data with a specific property is queried in the graph database, an accurate query result can be obtained based on the property index.

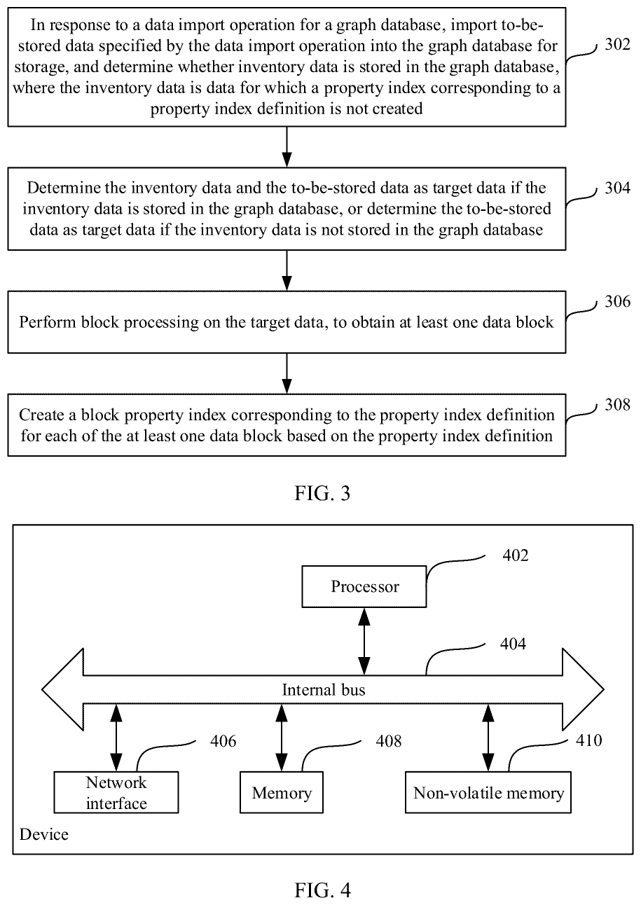

FIG. 3 is a flowchart of another property index creation method for a graph database according to an example embodiment of this application.

As shown in FIG. 3, the property index creation method for a graph database can include the following steps.

Step 302: In response to a data import operation for the graph database, import to-be-stored data specified by the data import operation into the graph database for storage, and determine whether inventory data is stored in the graph database, where the inventory data is data for which a property index corresponding to a property index definition is not created.

Step 304: Determine the inventory data and the to-be-stored data as the target data if the inventory data is stored in the graph database, or determine the to-be-stored data as the target data if the inventory data is not stored in the graph database.

For specific implementations of steps 302 to 304, refer to steps 202 to 204. Details are omitted in this application.

Step 306: Perform block processing on the target data, to obtain at least one data block.

In this embodiment, when the target data is determined, block processing can be first performed on the target data, to obtain the at least one data block.

In some embodiments, when block processing is performed on the target data, block processing can be specifically performed on the target data based on a data type, a data storage moment, and/or a data size.

For example, data of different data types can be divided into different data blocks based on the data type. To be specific, data organized into a node and an edge in the target data can be divided into different data blocks.

For another example, the data can be divided into a plurality of data blocks with the same data storage period length based on a data storage moment. In other words, time intervals between earliest data storage moments and latest data storage moments of data included in different data blocks are the same. For example, if an earliest data storage moment of data included in a data block A is 9:55 and a latest data storage moment is 10:00; and an earliest data storage moment of data included in a data block B is 10:00 and a latest data storage moment is 10:05, all data storage moments of the data included in the data block A are in a time period from 9:55 to 10:00, all data storage moments of the data included in the data block B are in a time period from 10:00 to 10:05, and the data block A and the data block B have the same data storage period length.

For another example, the target data can be divided into a plurality of data blocks with the same data size based on the data size. In other words, data sizes of data included in different data blocks are the same.

It should be noted that a data block policy can be set according to an actual requirement. For example, a data block can be further obtained based on a specific type (for example, a person, a location, or an event) of a node or a specific type (for example, “knowing”, “belonging”, and “located”) of an edge. This is not specifically limited in this application.

Step 308: Create a block property index corresponding to the property index definition for each of the at least one data block based on the property index definition.

In this embodiment, when the at least one data block is obtained, the property index corresponding to the property index definition can be created for each of the data block based on the property index definition. In this case, the created property index is a property index corresponding to a data block, and therefore can be referred to as a block property index.

In the above-mentioned embodiment, block processing is performed, based on data, on a property index created for the data. In this way, expiry-based eviction, a multi-version incremental backup, disaster recovery, etc. can be performed for the property index based on the block property index subsequently.

In some embodiments, after the block property index is created for the target data, expiry-based eviction can be periodically performed for the property index based on the block property index. Specifically, an expired index can be periodically determined from the block property index based on a preset time period (which can be referred to as a first time period, and can be set to a default value or based on a requirement), and eviction processing is performed on the determined expired index. In this way, the graph database supports expiry-based eviction for the property index. For a computing analysis scenario that relies only on recent data, storage costs can be reduced, and query performance can be improved.

In actual applications, based on a heartbeat mechanism, the expired index can be periodically determined from the block property index based on the first time period, and eviction processing is performed on the determined expired index.

The heartbeat mechanism is a commonly used technology for keeping a state in which a connection is active. Based on the heartbeat mechanism, a short message (which can be referred to as a heartbeat packet or a heartbeat signal) can be periodically sent, to trigger determining of the expired index from the block property index, and eviction processing on the determined expired index.

In some embodiments, when the expired index is determined from the block property index, a block property index created for an expired data block in the at least one data block can be specifically determined as an expired index. The expired data block can be a data block that includes data for which a time interval between a data storage moment and a current moment reaches a preset threshold (which can be set to a default value or based on a requirement).

In some embodiments, when eviction processing is performed on the expired index, the determined expired index can be specifically deleted; or index recreation can be performed based on data corresponding to an index in the block property index other than the determined expired index. It should be noted that, when index recreation is performed, the block property index can be recreated by performing, based on data, block processing on a property index created for the data, so that expiry-based eviction continues to be performed on the property index subsequently.

In some embodiments, after the block property index is created for the target data, the multi-version incremental backup of the property index based on the block property index can be periodically made. Specifically, whether a backup condition corresponding to a target block property index (each block property index can be sequentially used as the target block property index) is satisfied can be periodically determined based on a preset time period (which can be referred to as a second time period, and can be set to a default value or based on a requirement). If the backup condition is satisfied, an incremental backup of the target block property index can be made, and a preset quantity of backup versions of the target block property index can be stored. For example, if three backup versions of the target block property index can be stored, after the incremental backup of the target block property index is made, one backup version with the earliest backup moment (the longest time interval between the backup moment and a current moment) in the three currently stored backup versions of the target block property index can be replaced with one backup version that is of the target block property index and that is obtained through a current backup, to update the three stored backup versions of the target block property index. In this way, the graph database supports the multi-version incremental backup of the property index, so that not only storage costs can be reduced based on the incremental backup, but also adjustment can be performed based on the multi-version backup and a backup time interval, to avoid a problem that a large quantity of property indexes are lacked or lost due to an abnormal condition.

In actual applications, for a block property index, each time an incremental backup of the block property index is made, for a backup version that is of the block property index and that is obtained by making a current backup, a backup moment of the backup version can be recorded; or a version number of the backup version can be recorded, and the version number indicates a backup moment. For example, a larger version number indicates a later backup moment, and a smaller version number indicates an earlier backup moment.

Similarly to the expiry-based eviction for the property index, whether the backup condition corresponding to the target block property index is satisfied can be periodically determined based on the second time period. To be specific, whether the backup condition corresponding to the target block property index is satisfied can be triggered by periodically sending the heartbeat packet or the heartbeat signal.

In an actual application, the backup condition can be that a time interval between the current moment and a backup moment of a previous backup reaches a preset threshold (which can be set to a default value or based on a requirement), or can be that it is detected that the target block property index changes, and can be specifically set based on a requirement. This is not specifically limited in this application.

In some embodiments, if the graph database is abnormal, each block property index can be restored based on a backup version that is of each block property index and that has the latest backup moment (namely, a time interval between the backup moment and the current moment is the shortest). In this way, disaster recovery of the property index is facilitated because the graph database supports the multi-version incremental backup of the property index.

It should be noted that, to reduce operation execution complexity for the graph database, and reduce difficulty of performing expiry-based eviction and the multi-version incremental backup for the property index, after the block property index is created for the target data, whether the backup condition corresponding to the block property index is satisfied can be determined based on the heartbeat mechanism. If the backup condition is satisfied, the expired index can be first determined from the block property index, eviction processing is performed on the determined expired index, an incremental backup of each block property index remaining after expiry-based eviction is made, and the preset quantity of backup versions of the block property index are stored.

Corresponding to the above-mentioned embodiment of the property index creation method for a graph database, this application further provides an embodiment of a property index creation apparatus for a graph database.

FIG. 4 is a schematic structural diagram of a device according to an example embodiment of this application. At the hardware level, the device includes a processor 402, an internal bus 404, a network interface 406, a memory 408, and a non-volatile memory 410, and certainly may further include other required hardware. One or more embodiments of this application can be implemented based on software. For example, the processor 402 reads a corresponding computer program from the non-volatile memory 410 to the memory 408 and then runs the computer program. Certainly, in addition to a software implementation, one or more embodiments of this application do not rule out other implementations, such as an implementation of a logic device or a combination of software and hardware. In other words, an execution body of the following processing procedure is not limited to each logical module, and can be hardware or a logic device.

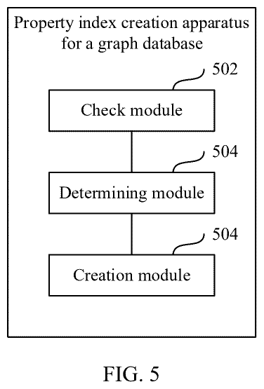

FIG. 5 is a block diagram of a property index creation apparatus for a graph database according to an example embodiment of this application.

The property index creation apparatus for a graph database can be used in the device shown in FIG. 4, to implement the technical solutions of this application. The apparatus includes:
a check module 502, configured to: in response to a data import operation for the graph database, import to-be-stored data specified by the data import operation into the graph database for storage, and determine whether inventory data is stored in the graph database, where the inventory data is data for which a property index corresponding to a property index definition is not created;
a determining module 504, configured to: determine the inventory data and the to-be-stored data as the target data if the inventory data is stored in the graph database, or determine the to-be-stored data as the target data if the inventory data is not stored in the graph database; and
a creation module 506, configured to: create the property index corresponding to the property index definition for the target data based on the property index definition.

In some embodiments, the creating the property index corresponding to the property index definition for the target data based on the property index definition includes:
performing block processing on the target data, to obtain at least one data block; and
creating a block property index corresponding to the property index definition for each of the at least one data block based on the property index definition.

In some embodiments, the performing block processing on the target data includes:
performing block processing on the target data based on a data type, a data storage moment, and/or a data size.

In some embodiments, the apparatus further includes:
an eviction module, configured to: determine, based on a preset first time period, an expired index from the block property index created for each of the at least one data block, and perform eviction processing on the expired index.

In some embodiments, the determining an expired index from the block property index created for each of the at least one data block includes:
determining, as an expired index, a block property index created for an expired data block in the at least one data block, where the expired data block is a data block that includes data for which a time interval between a data storage moment and a current moment reaches a preset threshold.

In some embodiments, the performing eviction processing on the expired index includes:
deleting the expired index; or
performing index recreation based on data corresponding to an index in the block property index other than the expired index.

In some embodiments, the apparatus further includes:
a determining module, configured to: determine, based on a preset second time period, whether a backup condition corresponding to a target block property index is satisfied; and
a backup module, configured to: if the backup condition is satisfied, make an incremental backup of the target block property index, and store a preset quantity of backup versions of the target block property index.

In some embodiments, the apparatus further includes:
a restoration module, configured to: if the graph database is abnormal, restore each block property index based on a backup version that is of each block property index and for which a time interval between a backup moment and a current moment is the shortest.

Because the apparatus embodiment basically corresponds to the method embodiment, for related parts, references can be made to related descriptions in the method embodiment. The described apparatus embodiments are merely examples. The modules described as separate parts may or may not be physically separate, and parts displayed as modules may or may not be physical modules, that is, may be located in one position, or may be distributed on a plurality of network modules. Some or all modules can be selected based on an actual requirement, to achieve objectives of the solutions of this application.

The system, apparatus, module, or unit described in the above-mentioned embodiment can be specifically implemented by a computer chip or an entity, or can be implemented by a product that has a function. A typical implementation device is a computer, and a specific form of the computer can be a personal computer, a laptop computer, a cellular phone, a camera phone, a smartphone, a personal digital assistant, a media player, a navigation device, an e-mail transceiver device, a game console, a tablet computer, a wearable device, or any combination of several devices in these devices.

In a typical configuration, the computer includes one or more central processing units (CPUs), an input/output interface, a network interface, and a memory.

The memory may include a non-persistent memory, a random access memory (RAM), a non-volatile memory, and/or another form in a computer-readable medium, for example, a read-only memory (ROM) or a flash memory (flash RAM). The memory is an example of the computer-readable medium.

Computer-readable media, including permanent and non-permanent, removable and non-removable media, can be implemented by any method or technology for information storage. The information can be a computer-readable instruction, a data structure, a program module, or other data. Examples of the computer storage medium include but are not limited to a phase change random access memory (PRAM), a static random access memory (SRAM), a dynamic random access memory (DRAM), a random access memory (RAM) of another type, a read-only memory (ROM), an electrically erasable programmable read-only memory (EEPROM), a flash memory or another memory technology, a compact disc read-only memory (CD-ROM), a digital versatile disc (DVD), or another optical storage, a cassette, a disk memory, a quantum memory, a graphene-based storage medium, another magnetic storage device, or any other non-transmission medium. The computer storage medium can be configured to store information that can be accessed by a computing device. As defined herein, the computer-readable medium does not include a transitory media (transitory media), such as a modulated data signal and a carrier.

It should be noted that the term “include”, “comprise” or any other variant thereof is intended to cover non-exclusive inclusion, so that a process, method, commodity, or device that includes a series of elements includes not only those elements but also other elements that are not explicitly listed, or includes elements inherent in such a process, method, commodity, or device. Without more constraints, an element preceded by “includes a . . . ” does not preclude the presence of additional identical elements in the process, method, product, or device that includes the element.

Specific embodiments of this application are described above. Other embodiments fall within the scope of this application. In some cases, actions or steps described in this application can be performed in a sequence different from that in the embodiments and desired results can still be achieved. In addition, the process depicted in the accompanying drawings does not necessarily need a particular sequence or consecutive sequence to achieve the desired results. In some implementations, multitasking and parallel processing are also feasible or can be advantageous.

Terms used in one or more embodiments of this application are merely used to describe specific embodiments, and are not intended to limit the one or more embodiments of this application. Terms “a”, “the”, and “this” in singular forms are also intended to include plural forms, unless otherwise stated in the context clearly. The term “and/or” is and includes any or all possible combinations of one or more associated listed items.

Descriptions of the terms “one embodiment”, “some embodiments”, “examples”, “specific examples”, or “one implementation” used in one or more embodiments of this application mean that a specific feature or characteristic described with reference to this embodiment is included in at least one embodiment of this application. Example descriptions of these terms do not need to be specific to the same embodiment. In addition, specific features or characteristics described can be combined in a proper manner in one or more embodiments of this application. In addition, different embodiments and specific features or characteristics in different embodiments can be combined, provided that they do not conflict with each other.

It should be understood that although terms “first”, “second”, “third”, etc. may be used in one or more embodiments of this application to describe various types of information, the information is not limited to these terms. These terms are merely used to distinguish between information of a same type. For example, without departing from the scope of one or more embodiments of this application, first information can also be referred to as second information, and similarly, the second information can be referred to as the first information. Depending on the context, the word “if” used here can be interpreted as “when” or “while” or “in response to determining”.

The above-mentioned descriptions are merely preferred embodiments in one or more embodiments of this application, but are not intended to limit the one or more embodiments of this application. Any modification, equivalent replacement, improvement, and the like made without departing from the spirit and principle of the one or more embodiments of this application shall fall within the protection scope of the one or more embodiments of this application.

User information (including but not limited to user equipment information, personal user information, and the like) and data (including but not limited to data used for analysis, stored data, displayed data, and the like) in this application are information and data that are authorized by a user or that are fully authorized by each party. Furthermore, related data needs to be collected, used, and processed in compliance with relevant laws, regulations and standards of relevant countries and regions, and corresponding operation entries are provided for the user to choose to authorize or reject.

1. A property index creation method for a graph database, wherein the method comprises:
in response to a data import operation for the graph database, importing to-be-stored data specified by the data import operation into the graph database for storage, and determining whether inventory data is stored in the graph database, wherein the inventory data is data for which a property index corresponding to a property index definition is not created;
determining the inventory data and the to-be-stored data as target data if the inventory data is stored in the graph database, or determining the to-be-stored data as the target data if the inventory data is not stored in the graph database; and
creating the property index corresponding to the property index definition for the target data based on the property index definition.

2. The method according to claim 1, wherein the creating the property index corresponding to the property index definition for the target data based on the property index definition comprises:
performing block processing on the target data, to obtain at least one data block; and
creating a block property index corresponding to the property index definition for each of the at least one data block based on the property index definition.

3. The method according to claim 2, wherein the performing block processing on the target data comprises:
performing block processing on the target data based on a data type, a data storage moment, and/or a data size.

4. The method according to claim 2, wherein the method further comprises:
determining, based on a preset first time period, an expired index from the block property index created for each of the at least one data block, and performing eviction processing on the expired index.

5. The method according to claim 4, wherein the determining an expired index from the block property index created for each of the at least one data block comprises:
determining, as an expired index, a block property index created for an expired data block in the at least one data block, wherein the expired data block is a data block that comprises data for which a time interval between a data storage moment and a current moment reaches a preset threshold.

6. The method according to claim 4, wherein the performing eviction processing on the expired index comprises:
deleting the expired index; or
performing index recreation based on data corresponding to an index in the block property index other than the expired index.

7. The method according to claim 2, wherein the method further comprises:
determining, based on a preset second time period, whether a backup condition corresponding to a target block property index is satisfied; and
if the backup condition is satisfied, making an incremental backup of the target block property index, and storing a preset quantity of backup versions of the target block property index.

8. The method according to claim 7, wherein the method further comprises:
if the graph database is abnormal, restoring each block property index based on a backup version that is of each block property index and for which a time interval between a backup moment and a current moment is the shortest.

9. (canceled)

10. An electronic device, comprising:
a processor; and
a memory, configured to store processor executable instructions, wherein the executable instructions, when executed by the processor, cause the electronic device to:
in response to a data import operation for the graph database, import to-be-stored data specified by the data import operation into the graph database for storage, and determine whether inventory data is stored in the graph database, wherein the inventory data is data for which a property index corresponding to a property index definition is not created;
determine the inventory data and the to-be-stored data as target data if the inventory data is stored in the graph database, or determine the to-be-stored data as the target data if the inventory data is not stored in the graph database; and
create the property index corresponding to the property index definition for the target data based on the property index definition.

11. (canceled)

12. The electronic device according to claim 10, wherein the electronic device being caused to create the property index corresponding to the property index definition for the target data based on the property index definition comprises being caused to:
perform block processing on the target data, to obtain at least one data block; and
create a block property index corresponding to the property index definition for each of the at least one data block based on the property index definition.

13. The electronic device according to claim 12, wherein the electronic device being caused to perform block processing on the target data comprises being caused to:
perform block processing on the target data based on a data type, a data storage moment, and/or a data size.

14. The electronic device according to claim 12, wherein the electronic device is further caused to:
determine, based on a preset first time period, an expired index from the block property index created for each of the at least one data block, and perform eviction processing on the expired index.

15. The electronic device according to claim 14, wherein the electronic device being caused to determine an expired index from the block property index created for each of the at least one data block comprises being caused to:
determine, as an expired index, a block property index created for an expired data block in the at least one data block, wherein the expired data block is a data block that comprises data for which a time interval between a data storage moment and a current moment reaches a preset threshold.

16. The electronic device according to claim 14, wherein the electronic device being caused to perform eviction processing on the expired index comprises being caused to:
delete the expired index; or
perform index recreation based on data corresponding to an index in the block property index other than the expired index.

17. The electronic device according to claim 12, wherein the electronic device is further caused to:
determine, based on a preset second time period, whether a backup condition corresponding to a target block property index is satisfied; and
if the backup condition is satisfied, make an incremental backup of the target block property index, and store a preset quantity of backup versions of the target block property index.

18. The electronic device according to claim 17, wherein the electronic device is further caused to:
if the graph database is abnormal, restore each block property index based on a backup version that is of each block property index and for which a time interval between a backup moment and a current moment is the shortest.

19. A non-transitory computer-readable storage medium storing instructions, wherein the non-transitory computer-readable storage medium stores a computer program, which when executed by a processor causes the processor to:
in response to a data import operation for the graph database, import to-be-stored data specified by the data import operation into the graph database for storage, and determine whether inventory data is stored in the graph database, wherein the inventory data is data for which a property index corresponding to a property index definition is not created;
determine the inventory data and the to-be-stored data as target data if the inventory data is stored in the graph database, or determine the to-be-stored data as the target data if the inventory data is not stored in the graph database; and
create the property index corresponding to the property index definition for the target data based on the property index definition.

20. The non-transitory computer-readable storage medium according to claim 19, wherein the processor being caused to create the property index corresponding to the property index definition for the target data based on the property index definition comprises being caused to:
perform block processing on the target data, to obtain at least one data block; and
create a block property index corresponding to the property index definition for each of the at least one data block based on the property index definition.

21. The non-transitory computer-readable storage medium according to claim 20, wherein the processor being caused to perform block processing on the target data comprises being caused to:
perform block processing on the target data based on a data type, a data storage moment, and/or a data size.

22. The non-transitory computer-readable storage medium according to claim 20, wherein the processor is further caused to:
determine, based on a preset first time period, an expired index from the block property index created for each of the at least one data block, and perform eviction processing on the expired index.
